(19) United States
(12) Patent Application Publication
(10) Pub. No.: US 2024/0255658 A1
(43) Pub. Date: Aug. 1, 2024

(54) READOUT METHOD AND READOUT DEVICE FOR READING ELECTRICAL SIGNALS FROM A PHOTOSENSITIVE SENSOR

(71) Applicant: TRIXELL, MOIRANS (FR)

(72) Inventor: Martin SIAUD, MOIRANS (FR)

(21) Appl. No.: 18/423,237

(22) Filed: Jan. 25, 2024

(30) Foreign Application Priority Data
Jan. 27, 2023 (FR) 2300800

(51) Int. Cl. G01T 1/24

(52) U.S. Cl. CPC G01T 1/247

(57) ABSTRACT

A readout method for reading a sensor includes a matrix of pixels sensitive to a physical phenomenon and delivering an electrical signal the level of which depends on the intensity of the physical phenomenon, the pixels being organized into rows and being connected, via conductors, to readout circuits of the sensor, the readout circuits each comprising an analogue-to-digital converter receiving the electrical signal and delivering digital information depending on the electrical signal. The method comprises the following phases for the readout of each pixel: the matrix of pixels acquiring electric charges; and reading the matrix by transferring the charges acquired during the acquisition phase to the readout circuits, wherein, during the readout phase, multiple successive analogue-to-digital conversions of the acquired charges are carried out in parallel with one and the same acquisition phase. A readout device comprising the readout circuits of the sensor and configured to implement the readout method.

### CROSS-REFERENCE TO RELATED APPLICATION

This application claims priority to foreign French patent application No. FR 2300800, filed on Jan. 27, 2023, the disclosure of which is incorporated by reference in its entirety.

### FIELD OF THE INVENTION

The invention relates to the field of semiconductor-based imagers for detecting X-rays. It relates in particular to a readout method for reading a photosensitive sensor.

### BACKGROUND

Photosensitive sensors are used for the imaging of ionizing radiation, and notably X-ray radiation, for the detection of radiological images in the medical field, or that of non-destructive testing in the industrial field, or that of safety.

Generally speaking, the photosensitive sensor comprises a large number of photosensitive dots, called pixels, generally organized in a matrix or in a strip. In a photosensitive sensor, a pixel represents the elementary sensitive element of the sensor. Each pixel converts the electromagnetic radiation to which it is subjected into an electrical signal. The electrical signals from the various pixels are collected by readout circuits during a phase of reading the matrix and are then digitized so as to be able to be processed and stored in order to form an image.

The pixels comprise a photosensitive zone that delivers a current of electric charges depending on the photon flux that it receives, and an electronic circuit. The photosensitive zone generally comprises a photosensitive element, or photodetector, which may for example be a photodiode, a photoresistor or a phototransistor. The electronic circuit consists for example of switches, capacitors and resistors, downstream of which an actuator is located. The assembly consisting of the photosensitive element and the electronic circuit makes it possible to generate electric charges and to collect them. The electronic circuit generally makes it possible to reset the charge collected in each pixel after a charge transfer. The actuator has the role of transferring or copying the charges collected by the circuit to a column conductor. This transfer is carried out when the actuator receives the instruction to do so from a line conductor. The output of the actuator corresponds to the output of the pixel.

In this type of sensor, a pixel operates in two phases: an image capture phase, during which the electronic circuit of the pixel accumulates the electric charges generated by the photosensitive element, and a readout phase, during which the collected charges are transferred or copied to the column conductor, by virtue of the actuator.

During the readout phase, a read instruction is sent to all of the actuators of one and the same line of the matrix by way of a line conductor. Each of the pixels of this line is read by transferring its electrical information, charge, voltage, current, frequency, etc., to the column conductor with which it is associated.

For an image frame, the lines of pixels may be selected in sequence, one after the other in a scanning direction of the lines of the matrix, during a line selection time corresponding to a fraction of the duration of the frame, enabling appropriate signals, for example voltages, to be applied to the pixels of the line in question. The selection of a line thus corresponds to the application, during a corresponding line selection time, of a high-level signal controlling the on state of the switching devices of the corresponding line of pixels. Outside of the line selection time, the switching devices are kept in an off state by applying an appropriate low-level signal. For example, when the switching devices are transistors, the signals to be applied then being voltages, it is common to use VGon to denote the voltage corresponding to the high level and hence to the on state of the switching transistor, and to use VGoff to denote the voltage corresponding to the low level and to the off state of the switching transistor.

Photosensitive sensors are often produced by way of techniques involving the deposition of thin films of semiconductor materials on a glass-based or silicon-based substrate. The pixel technologies used in large-area imagers are historically amorphous silicon due to the low production cost thereof compared to crystalline silicon technologies, known in the literature by their abbreviation CMOS for “complementary metal-oxide semiconductor”. On the other hand, the technical possibilities are limited. Only passive pixels are able to be produced (a single charge transfer transistor).

For a passive-pixel matrix, the readout circuit comprises multiple stages, notably a charge-voltage stage converting the charges received by the photodetector into a voltage, upstream of an analogue-to-digital converter.

Electronic noise is generated in the matrix of pixels and in the various stages of each readout circuit. In low-sensitivity applications, the predominant noise source is that of the analogue-to-digital converter, whereas, in high-sensitivity applications, the noise of the analogue-to-digital converter is negligible compared to the noise upstream of the matrix of pixels and of the various stages of the readout circuit (input stage and charge-voltage stage).

To reduce noise in high-sensitivity applications, there are various options in the prior art, such as increasing the image capture duration (also called acquisition duration or integration duration).

To be effective, the solutions from the prior art require a significant extension of the duration needed to produce the image (corresponding to the addition of the integration duration and the readout duration). This is not compatible with the image frequencies used for current applications.

Another improvement consists in separating a substrate (often called a slab) bearing the pixels into two symmetrical parts. The separation consists in placing readout circuits on either side of the slab. The length of the columns is thus halved. The column resistance is therefore halved, significantly reducing the major noise source of the passive sensor. However, this solution requires doubling the number of readout circuits, and therefore entails a high cost.

### SUMMARY OF THE INVENTION

The invention aims to propose a readout method for reading a photosensitive sensor that is easy to implement and economical, making it possible to reduce the noise on the predominant noise sources both at the analogue-to-digital converter and upstream of said converter, that is to say over the entire acquisition chain.

To this end, the invention proposes a readout method for reading a sensor comprising a matrix of pixels sensitive to a physical phenomenon and delivering an electrical signal the level of which depends on the intensity of the physical phenomenon, the pixels being organized into rows and being connected, via conductors, to readout circuits of the sensor, the readout circuits each comprising an analogue-to-digital converter receiving the electrical signal and delivering digital information depending on the electrical signal, wherein the method comprises the following phases for the readout of each pixel:
the matrix of pixels acquiring electric charges;
reading the matrix by transferring the charges acquired during the acquisition phase to the readout circuits;
wherein, during the readout phase, multiple successive analogue-to-digital conversions of the acquired charges are carried out in parallel with one and the same acquisition phase.

The solution provided by the invention thus consists in performing multiple successive analogue-to-digital conversions in parallel with the acquisition of a signal. The conversions are carried out on the same signal acquisition phase.

In other words, the acquisition of the signal is retained and said acquired signal is regularly converted. In yet other words, the signal is converted during acquisition thereof and as it is acquired.

Carrying out these multiple conversions is thus tantamount to carrying out conversions on multiple parts of the acquired signal, and therefore to carrying out the sampling and the analogue-to-digital conversion of the signal in parallel.

By carrying out N conversions, the conversions take place over time intervals that are N times smaller. The cut-off frequency variation of an input stage of the readout circuit is therefore N times smaller on the converted signal. However, the column thermal noise and the input stage noise depend on the cut-off frequency of the input stage. The column thermal noise and the input stage noise are thus divided by \sqrt{N}. Since these noises are the predominant noises in the sensor, the total noise of the sensor is thus reduced essentially by a factor of \sqrt{N}.

By virtue of the invention, the noise of the sensor is reduced on the predominant sources over the entire signal acquisition chain, and not only over part of the acquisition chain (for example only at the analogue-to-digital converter).

Some practical particular preferred features of the readout method according to the invention are presented below.

The pixels are passive.

The electrical signal delivered by the pixels is an electric charge. The readout circuits each comprise a charge-voltage stage configured to convert electric charges received from the pixels into a voltage, the voltage being delivered to the analogue-to-digital converter.

Each readout circuit comprises an input stage comprising an amplifier and a transistor, the amplifier having an inverting input connected to one of the pixels and an output connected to the gate of the transistor.

The amplifier is configured to amplify the potential difference between a voltage of a row of the matrix of pixels and an input reference voltage. The amplifier is also configured to control the transistor by way of a control voltage.

The method comprises at least one automatic reset of each readout circuit by way of the input stage during the acquisition of the electric charges.

Each readout circuit comprises a sample-and-hold unit that is driven in conduction mode throughout the readout phase.

The analogue-to-digital converter is a sigma-delta converter.

The conversions are carried out at regular intervals during the same acquisition phase. In other words, the analogue-to-digital conversions are spaced by one and the same time interval. In yet other words, the time interval separating two successive conversions is constant throughout the readout phase.

According to another aspect, the invention also relates to a readout device for reading electrical signals from sensors comprising a matrix of pixels sensitive to a physical phenomenon and configured to deliver an electrical signal the level of which depends on the intensity of the physical phenomenon, the readout device comprising the readout circuits of the sensor and being configured to implement the readout method having at least one of the above features. The pixels are organized into rows and are connected, via conductors, to the readout circuits of the readout device, the readout circuits each comprising an analogue-to-digital converter receiving the electrical signal and delivering digital information depending on the electrical signal. The analogue-to-digital converter is a sigma-delta converter.

### BRIEF DESCRIPTION OF THE DRAWINGS

Other features and advantages of the invention will become more apparent from the following description with reference to the attached drawings, which are given by way of non-limiting example:

FIG. 1 schematically shows one example of a matrix of 1T pixels known from the prior art;

FIG. 2 schematically shows an assembly comprising a pixel and a readout device for reading an electrical signal from the pixel, according to one embodiment of the invention; and

FIG. 3 is a depiction of timing diagrams illustrating a readout method according to one embodiment of the invention.

### DETAILED DESCRIPTION

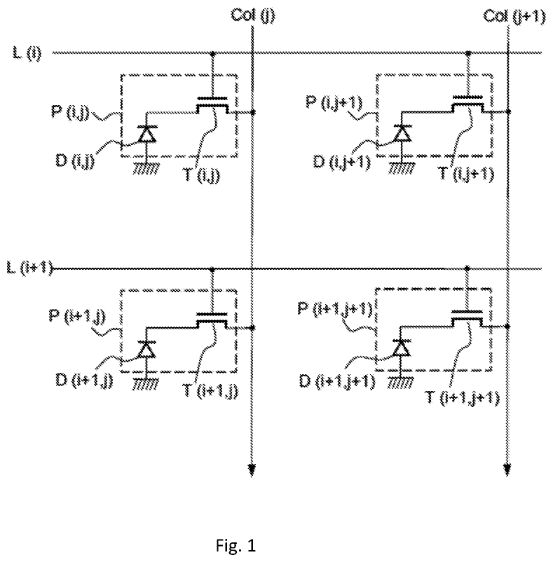

FIG. 1 schematically shows a matrix known from the prior art. The matrix comprises two lines and two columns to simplify understanding. Four pixels P are formed, each at the intersection of a line and a column. It will be readily understood that real matrices are generally much larger and have a large number of lines and columns. The matrix belongs to a matrix detector for producing digitized images.

Each pixel P comprises a photosensitive zone, represented here by a photodiode D, and an electronic processing circuit formed, in the example of FIG. 1, by a single transistor T. The references for the components D and T are followed by two coordinates specifying the rank of the line, respectively i and i+1, and that of the column, respectively j and j+1. The lines and columns are ordered in the physical order that they occupy in the matrix of pixels. The pixels that are shown are also called 1T pixels because they each have a transistor, the function of which will be described below.

The pixels P of one and the same column are connected to a column conductor Col. The column conductor Col makes it possible to collect information from the pixels that are connected thereto.

The pixels P of one and the same line are connected to a line conductor L carrying a signal VG for controlling each of the lines of pixels. Control circuits, not shown in FIG. 1, generally shift registers, generating the control signals carried by the line conductor L when it is used, are connected to the corresponding line conductors.

During an image capture phase, the illumination received by each of the photodiodes D causes a decrease in the potential of its cathode on which charges accumulate depending on the received illumination. This image capture phase is followed by a readout phase during which the potential of the photodiode D is read. To this end, the transistor T is turned on, and therefore acts as a switch, by virtue of a line selection command carried by the conductor L and applied to its gate. The transistor T is controlled by the control signal VG applied to its gate. The various lines of pixels are read sequentially. The column conductors Col are used sequentially to collect information from the pixels of the various columns when said column is selected. The readout phase drains the charges from the photodiode D and allows it to be reset before a new image capture phase.

The control circuits are arranged at the end of a line. Moreover, readout circuits are arranged at the end of each of the column conductors Col.

The designation line and column is purely arbitrary and could be reversed. In practice, the control circuits may be arranged on one side of the matrix and the readout circuits may be arranged on a side of the matrix perpendicular to the side on which the control circuits are located. To simplify the connection of the various circuits, it is also possible to arrange all of the circuits, the control and readout circuits, on one and the same side of the matrix. A line or a column may also be referred to here using the term row.

The readout circuits associated with the column conductors Col make it possible for example to digitize the signals collected on the column conductors. The various readout circuits may comprise a multiplexer for combining the signals from an entire line of pixels. Once a line has been read by the readout circuits, it is possible to select a new line to reiterate the readout operation.

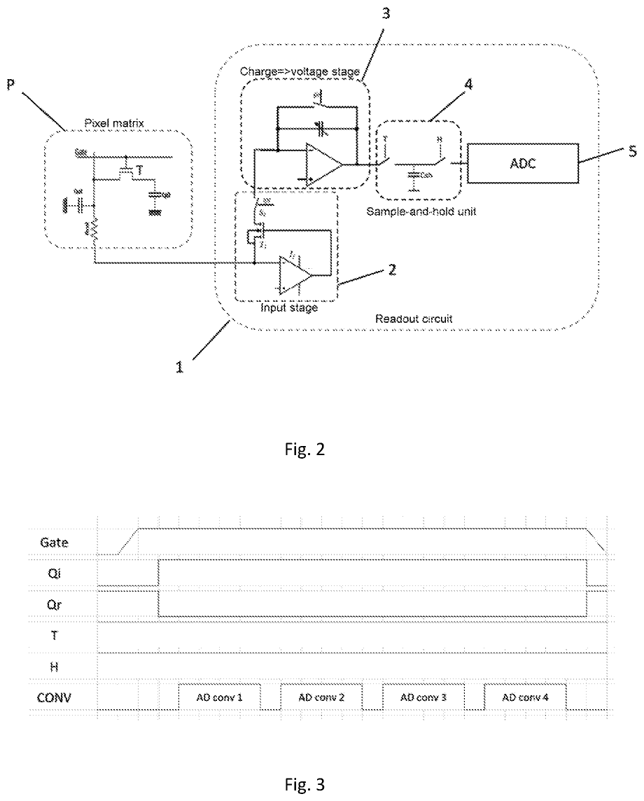

FIG. 2 shows, in simplified and schematic form, a readout device for reading electrical signals from a photosensitive sensor according to the invention.

The readout device comprises multiple readout circuits 1. Each readout circuit is connected to the end of one of the column conductors of the matrix of pixels. For the sake of simplification and clarity, the diagram shows a single readout circuit 1 and a single pixel P of the matrix of pixels.

The pixel P, which is a 1T pixel, comprises an electronic processing circuit formed by the transistor T.

The transistor T is controlled by a signal Gate.

The pixel P comprises a photosensitive zone that delivers a current of electric charges depending on the photon flux that it receives. The photosensitive zone comprises a photodetector, such as for example a photodiode, a photoresistor or a phototransistor. The photosensitive zone is configured to collect the charges from the photos, and thus behaves like a capacitor. The photosensitive zone is represented here by a capacitor CpD.

The resistor Rcol and the capacitor Ccol shown in the pixel correspond to the parasitic column resistance and the parasitic column capacitance resulting from the configuration and the dimensions of the matrix of pixels. Indeed, the photosensitive sensor has large dimensions. The width and length of the photosensitive sensor may exceed 400 mm, whereas the thickness is small.

The pixel P operates in two phases, an acquisition phase and a readout phase.

During the acquisition phase, the electronic circuit of the pixel accumulates the electric charges generated by the photosensitive element. The transistor T is open during the acquisition phase.

Once the acquisition phase has ended, the transistor T is closed. The acquired charges are transferred or copied to the column conductor to the readout circuit 1. This corresponds to the readout phase.

The readout circuit 1 here comprises an input stage 2, a charge-voltage stage 3, a sample-and-hold unit 4 and an analogue-to-digital converter ADC 5.

The input stage 2 is connected to the column conductor of the pixel P. The input stage 2 is a stage for pre-amplifying the charges acquired by the pixel P.

The input stage 2 comprises an amplifier I_{I}, a transistor T_{I} and a switch Q_{I}.

The amplifier I_{I} is an operational amplifier. The inverting input of the amplifier I_{I} is connected to the pixel P, notably to the column conductor.

The transistor T_{I} is an insulated-gate field-effect transistor, more commonly called a MOSFET (metal oxide-semiconductor field-effect transistor). The gate of the transistor T_{I} is connected to the output of the amplifier I_{I}. The source of the transistor T_{I} is connected to the inverting input of the amplifier I_{I}. The drain of the transistor is connected to the switch Q_{I}.

The switch Q_{I} is closed during the electric charge integration phase. The charges may then transit from the input stage 2 to the charge-voltage stage 3. The switch Q_{I} is open outside the electric charge integration. The electric charges cannot transit to the charge-voltage stage 3. The switch Q_{I} is controlled by an external signal, notably a logic signal. The external signal makes it possible to open or close the switch Q_{I}.

The transistor T_{I} may be in an on state or an off state. The transistor T_{I} is in the on state as soon as the voltage applied thereto is at least equal to a threshold voltage V_{th_TI}. In other words, the threshold voltage V_{th_TI} corresponds to the switching threshold for changing from one state to the other from among the on state and the off state.

The amplifier I_{I} amplifies the potential difference Vin between the column voltage Vcol and an input reference voltage AGND. The input reference voltage is ground here. The amplifier I_{I} controls the transistor T_{I}, called transfer transistor, by way of a control voltage Vctrl.

The amplifier I_{I} behaves like a high-gain inverting amplifier. The voltage V_{ctrl} is inversely proportional to the voltage difference Vin=Vcol−AGND=Vcol. In other words, the control voltage Vctrl is inversely proportional to the input voltage of the amplifier I_{I}.

The charge-voltage stage 3 comprises an amplifier Iᵣ, a capacitor Cᵣ and a switch Qᵣ that are connected in parallel.

The amplifier Iᵣ is an operational amplifier. The inverting input of the amplifier Iᵣ is connected to the switch Q_{I} of the input stage 2. The output of the amplifier Iᵣ is connected to the sample-and-hold unit 4.

The capacitor Cᵣ is in the feedback from the amplifier Iᵣ. The capacitor Cᵣ is a variable capacitor. The variable capacitor makes it possible to have a programmable charge-voltage gain.

The charge-voltage stage 3 makes it possible to transform the acquired charges of the pixel P into a voltage. The obtained voltage is transmitted to the sample-and-hold unit 4.

The sample-and-hold unit 4 comprises two switches T and H and a capacitor Csh.

The sample-and-hold unit 4 constitutes the input of the analogue-to-digital converter. The sample-and-hold unit 4 makes it possible, in a conventional manner, to take the voltage received from the charge-voltage stage 3 at each sampling instant, and also to keep the last sample at a constant value. For this purpose, the switches T and H are opened and closed alternately.

During conventional operation of the sample-and-hold unit 4, when the switch T is open and the switch H is closed, the capacitor Csh accumulates the voltage. When the switch T is closed and the switch H is open, the capacitor Csh releases the voltage to the analogue-to-digital converter. The sample-and-hold unit 4 thus makes it possible to maintain the voltage at the input of the analogue-to-digital converter 5 so that the latter has enough time to process the voltage and convert it. The analogue voltage is therefore stable throughout the duration of the digital conversion.

Preferably, the analogue-to-digital converter 5 is a sigma-delta converter. As an alternative, the analogue-to-digital converter 5 is a successive approximation register (SAR) converter.

The readout circuit 1 is able to operate in two modes: a sample-and-convert mode and a nominal mode. In the sample-and-convert mode, multiple signal conversions are carried out in parallel with the acquisition of electric charges, as explained below.

FIG. 3 shows the timing diagrams of the components of the readout circuit 1 when the pixel P is in the readout phase. The readout circuit 1 here is in the sample-and-convert mode.

During the readout phase, the gate of the transistor T of the pixel P is at level 1. The transistor T is in the on state. This is made possible by a line selection command carried by the conductor L and applied to the gate.

The electric charges acquired during the acquisition phase are then sent to the readout circuit 1.

When the electric charges are transmitted from the pixel P to the column, the column voltage Vcol and therefore the voltage Vin increases. The control voltage Vctrl drops in proportion to the column voltage Vcol. The amplifier I_{I} is in the on state for as long as the control voltage Vctrl is greater than the threshold voltage V_{th_TI}. The electric charges are transferred to the charge-voltage stage 3 if the switch Q_{I} is closed. As the electric charges are transferred from the column to the input stage 2, the transistor T_{I} becomes progressively less conductive.

When the electric charges are transmitted from the pixel P to the column, the column voltage Vcol increases until it reaches the reference voltage AGND, in this case ground, and therefore 0 V. When the column voltage Vcol exceeds the zero reference voltage AGND, the control voltage then becomes negative. The control voltage Vctrl is lower than the threshold voltage V_{th_TI}. The transistor T_{I} is in the off state. The electric charges do not transit to the charge-voltage stage 3. The column thus returns to its equilibrium potential.

The input stage 2 configured in this way makes it possible to automatically reset the readout circuit. The automatic reset is carried out at the same time as the acquisition of the electric charges. The input stage 2 makes it possible to dynamically control the input voltage of the readout circuit 1.

In the readout circuit, the switch Q_{I} of the input stage 2 is closed. The acquired charges are transmitted to the charge-voltage stage 3 in order to transform the charges into a voltage.

The switch Qᵣ of the charge-voltage stage is open during the readout phase. The reset is therefore not performed during the readout phase. The voltage is sent to the input of the sample-and-hold unit 4.

Throughout the readout phase, the two switches T and H are closed. The sample-and-hold unit 4 is therefore driven in conduction mode. In other words, in the sample-and-convert mode, the sample-and-hold unit 4 corresponds to a wire connecting the charge-voltage stage 3 to the analogue-to-digital converter 5. The voltage is therefore sent from the charge-voltage stage 3 to the analogue-to-digital converter 5 without processing by the sample-and-hold unit 4. The voltage signal proportional to the quantity of charges acquired is applied to the input of the digital-to-analogue converter in real time.

The analogue-to-digital converter 5 carries out multiple successive conversions, for example four here. The successive conversions are performed at the same time as the acquisition or integration of the charges.

As may be seen in FIG. 3, a delay between the activation of the integration (the switch Q_{I} is open at the beginning and closed only after a period of time) and the first conversion is applied. This makes it possible to guarantee a sufficient voltage signal establishment time and thus minimize conversion errors.

In each conversion, the voltage signal is virtually constant (apart from leaks). The analogue-to-digital converter 5 is advantageously a sigma-delta converter, thereby enabling it to filter slight variations in the voltage signal.

The switch Qᵣ is kept open throughout the readout phase. The signal between each conversion is thus preserved. The reset is performed, by closing the switch Qᵣ, between each charge integration.

Digital processing may be performed at the end of the readout phase by averaging the N conversions downstream of the analogue-to-digital converter 5. The digitized signal at output is thus constant.

The electronic noise of a passive-pixel matrix digital detector originates from multiple sources, in the pixel matrix but also in the readout circuit. Two main noises are the column thermal noise and the input stage noise.

The noise of the input stage of the readout circuit depends on the cut-off frequency Δf of the input stage of the readout circuit. The cut-off frequency varies temporally with the charge integration.

The bandwidth of the input stage 2 depends on the bandwidth of the transistor T_{I}. The bandwidth of the input stage 2 is approximately equal to

$$\frac{1}{4 {R}_{{in}_{mpx}} {C}_{col}} , ,$$

wherein Rᵢₙ_{ₘₚₓ} is the resistance of the transistor T_{I}, and C_{col} corresponds to the sum of the parasitic capacitance of the input stage and the parasitic column capacitance resulting from the configuration and the dimensions of the matrix of pixels. The resistance of the transistor T_{I}, Rᵢₙ_{ₘₚₓ}, depends on the control voltage Vctrl of the transistor T_{I}. In other words, the resistance of the transistor T_{I}, Rᵢₙ_{ₘₚₓ}, depends on the electric charges arriving at input.

When the transistor T_{I} is conductive in weak inversion mode, the resistance of the transistor T_{I}, Rᵢₙ_{ₘₚₓ}, is proportional to

$$1 / exp ( \frac{Vgs}{nVt} ) ,$$

where n>1 (generally between 1.2 and 1.7, for example equal to 1.5), and Vgs is the potential difference between the gate and the source. Vt is equal to

$$\frac{kT}{q} ,$$

where k is the Boltzmann constant, having the value k=1.3806×10⁻²³ J.K⁻¹, and T is the absolute temperature and q is the absolute value of the electron charge (1.602×10⁻¹⁹ C). The resistance of the transistor T_{I}, Rᵢₙ_{ₘₚₓ}, is therefore proportional to

$$1 / exp ( \frac{Vctrl}{nVt} ) ,$$

here. The bandwidth of the input stage 2 is dynamic and depends temporally on the influx of electric charges.

A simplified model of the column thermal noise (in terms of charge), also known as resistance noise or Johnson noise, is as follows: σ_{col}=\sqrt{4kTR_{col}Δ_{f}}·Cₚₐᵣ, where σ_{col} is the standard deviation of the voltage across the terminals of the column resistor, k is the Boltzmann constant, having the value k=1.3806×10⁻²³ J.K⁻¹, and T is the absolute temperature of the column resistor.

The column thermal noise depends on the cut-off frequency Δf of the input stage of the readout circuit. The column thermal noise therefore also varies temporally with the electric charge integration.

In other words, the column thermal noise depends on the bandwidth of the input stage. The higher the resistance of the transistor T_{I}, Rᵢₙ_{ₘₚₓ}, the smaller the bandwidth of the input stage, and therefore the lower the column noise.

The bandwidth of the input stage 2 varies temporally depending on the integration time. The input stage noise therefore depends on the integration time. As a result, the column noise depends on the integration time. As the electric charges are integrated, the residual charges decrease. The bandwidth then becomes increasingly small, and thus the column thermal noise becomes increasingly low.

In the nominal mode of the readout circuit 1, the sample-and-hold unit 4 operates in a conventional operating mode. In other words, the switches T and H are opened and closed alternately. When the switch T is open and the switch H is closed, the capacitor Csh accumulates voltage. When the switch T is closed and the switch H is open, the capacitor Csh releases the voltage to the analogue-to-digital converter.

The presence of the sample-and-hold unit 4 in the readout circuit 1 makes it possible to operate the readout circuit 1 in both modes: the sample-and-convert mode and the nominal mode. The sample-and-convert mode, in which the sample-and-hold unit 4 is transparent, is used when it is desired to parallelize the electric charge integration and the analogue-to-digital conversion.

By virtue of the sample-and-hold unit 4, it is possible to offer various modes of use depending on the desired application. For some applications, there is a need to have a very high image acquisition frequency, but not necessarily low noise. Conversely, for other applications, there is a need to have low noise, but not necessarily a very high image acquisition frequency. The sample-and-hold unit thus makes it possible to offer fast modes with more noise and slower modes with less noise.

In contrast to the prior art, in which sampling and holding is performed and then followed by multiple conversions, the invention makes it possible to carry out conversion in parallel with the electric charge integration. The signal is converted with a different noise level in each conversion. This is made possible by the fact that the signal is essentially established on the various samples and that the total signal is obtained by averaging it. Averaging the column noise and the input stage noise reduces the overall noise.

By virtue of the invention and notably the multiple conversions during one and the same acquisition phase, the output signal is constant with a readout noise that is reduced by a factor of \sqrt{N}. In other words, the column thermal noise and the input stage noise are divided by \sqrt{N}. Since these noises are the predominant noises in the sensor, the total noise of the sensor is thus reduced essentially by a factor of \sqrt{N}.

The readout method and the readout device for reading electrical signals from photosensitive sensors according to the invention make it possible, by performing multiple conversions at the same time as the acquisition of the signal, to significantly reduce the noise in the sensor over the entire signal acquisition chain.

Differences in the integrated signal are also minimal. Furthermore, by virtue of a sigma-delta converter, the signal is filtered, meaning that slight variations in the signal have no impact.

The invention is particularly suitable for 1T passive imagers.

1. A readout method for reading a sensor comprising a matrix of pixels (P) sensitive to a physical phenomenon and delivering an electrical signal the level of which depends on the intensity of the physical phenomenon, the pixels being organized into rows and being connected, via conductors (Col), to readout circuits of the sensor, the readout circuits each comprising an analogue-to-digital converter receiving the electrical signal and delivering digital information depending on the electrical signal, wherein the method comprises the following phases for the readout of each pixel:
the matrix of pixels acquiring electric charges;
reading the matrix by transferring the charges acquired during the acquisition phase to the readout circuits;
wherein, during the readout phase, multiple successive analogue-to-digital conversions of the acquired charges are carried out in parallel with one and the same acquisition phase.

2. The readout method according to claim 1, wherein the pixels are passive.

3. The readout method according to claim 1, wherein the electrical signal delivered by the pixels is an electric charge and wherein the readout circuits each comprise a charge-voltage stage configured to convert electric charges received from the pixels into a voltage, the voltage being delivered to the analogue-to-digital converter.

4. The readout method according to claim 1, wherein each readout circuit comprises an input stage comprising an amplifier (I_{I}) and a transistor (T_{I}), the amplifier (I_{I}) having an inverting input connected to one of the pixels (P) and an output connected to the gate of the transistor (T_{I}), the amplifier (I_{I}) being configured to amplify the potential difference between a voltage of a row (Vcol) of the matrix of pixels and an input reference voltage (AGND), and to control the transistor (T_{I}) by way of a control voltage (V_{ctrl}).

5. The readout method according to claim 4, comprising at least one automatic reset of each readout circuit by way of the input stage during the acquisition of the electric charges.

6. The readout method according to claim 1, wherein each readout circuit comprises a sample-and-hold unit that is driven in conduction mode throughout the readout phase.

7. The readout method according to claim 1, wherein the analogue-to-digital converter is a sigma-delta converter.

8. The readout method according to claim 1, wherein the conversions are carried out at regular intervals during the same acquisition phase.

9. A readout device for reading electrical signals from sensors comprising a matrix of pixels (P) sensitive to a physical phenomenon and configured to deliver an electrical signal the level of which depends on the intensity of the physical phenomenon, the readout device comprising the readout circuits of the sensor and being configured to implement the readout method according to claim 1, the pixels being organized into rows and being connected, via conductors, to the readout circuits of the readout device, the readout circuits each comprising an analogue-to-digital converter receiving the electrical signal and delivering digital information depending on the electrical signal.

10. The readout device according to claim 9, wherein the analogue-to-digital converter is a sigma-delta converter.
